(19) United States
(12) Patent Application Publication
(10) Pub. No.: US 2014/0186551 A1
(43) Pub. Date: Jul. 3, 2014

(54) SMOOTH SOLDER DEPOSITION PROCESS

(71) Applicant: Government of the United States of America, as Represented by the Secretary of the Air Force, (US)

(72) Inventors: Tuoc N. Dang, Dayton, OH (US); Robert G. Bedford, Beavercreek, OH (US); Antao Chen, Lake Forest Park, WA (US)

(73) Assignee: Government of the United States of America, as represented by the Secretary of the Air Force, Wright-Patterson AFB, OH (US)

(21) Appl. No.: 13/733,603

(22) Filed: Jan. 3, 2013

(51) Int. Cl. B23K 1/20

(52) U.S. Cl. CPC B23K 1/20
USPC 427/597; 427/250

(57) ABSTRACT

A method of depositing solder material onto a substrate. The method includes adjusting a pressure within a vacuum chamber, the substrate being supported within the vacuum chamber. A temperature of the substrate is reduced such that the absolute temperature of the substrate is no greater than 20% of a melting temperature of the solder material The absolute temperature is maintained while solder material is deposited onto the substrate.

### RIGHTS OF THE GOVERNMENT

The invention described herein may be manufactured and used by or for the Government of the United States for all governmental purposes without the payment of any royalty.

### FIELD OF THE INVENTION

The present invention relates generally to vacuum-deposition methods and, more particularly, to methods of solder vacuum-deposition.

### BACKGROUND OF THE INVENTION

For devices that generate heat during operation, thermal effects may significantly limit performance. For example, device reliability and longevity may be related to excessive operating temperature while device fatigue may be related to thermal cycling. Therefore, a goal of device manufacturers is to efficiently remove heat generated by the device during its use. One conventional method of removing heat is a heat spreader coupled to the device using a solder bond. Selection of the solder material is driven by the thermal and electrical characteristics of the device and/or the heat spreader. If a high thermal conductivity heat spreader is required, then the soldier material may include indium, which has high thermal conductivity

$$( \sim 80 \frac{W}{mK} )$$

and provides a good link between the device and the heat spreader. In one specific example, manufacturing high-power, vertical external cavity, surface emitting lasers, the solder material must be as thin and smooth as possible. A thin solder layer decreases the total thermal impedance imparted by the solder while a smooth solder layer conforms to lower spatial frequency components and facilitates bond uniformity.

Placement of the solder material has been accomplished, generally, by using either preforms or by direct deposition. Solder bumps prepared from preforms tend to be thick (ranging from 30 μm to about 50 μm) prior to bonding, compress to 10 μm on bonding, are subject to chemical oxidation, and require application of bonding pressures. Direct deposition is limited by the solder material melting point and/or excessive energy during deposition, which can lead to crystal formation upon contacting the substrate. Crystal formation may be measured as surface roughness, which may exceed 1 μm (over a 400 μm² area of a 5 μm thick film) with evaporated deposition and 550 nm with sputter deposition processes. While solder layers deposited by sputter processes may be further smoothed by a subsequent reflow process (to approximately 200 nm), the grain size tends to increase due to coalescing. Also, the reflow process may cause mechanical stress to the substrate. The surface roughness is demonstrated in the focus ion-beam-etched cross-section scanning electron micrograph of a device 10 in FIG. 1. The device 10, having a sputtered indium film 12 proximate a heat-spreader interface 14, includes a Pt-Au solder adhesion layer 16 with the 2 μm layer of solder. Caverns 18 formed within the indium solder layer 12 reduce the net thermal conductivity.

Accordingly, improvements in solder layer deposition are needed for obtaining reduced grain size, reduced the potential for cavern formation and coalescing, decreased layer thickness, and smooth surfaces.

### SUMMARY OF THE INVENTION

The present invention overcomes the foregoing problems and other shortcomings, drawbacks, and challenges of conventional solder material deposition. While the invention will be described in connection with certain embodiments, it will be understood. that the invention is not limited to these embodiments. To the contrary, this invention includes all alternatives, modifications, and equivalents as may be included within the spirit and scope of the present invention.

According to one embodiment of the present invention a method of depositing solder material onto a substrate includes adjusting a pressure within a vacuum chamber, the substrate being supported within the vacuum chamber. A temperature of the substrate is reduced such that the absolute temperature of the substrate is no greater than 20% of a melting temperature of the solder material. The absolute temperature is maintained while solder material is deposited onto the substrate.

Another embodiment of the present invention is directed to a method of fabricating a flip chip and includes preparing a bond pad site on a substrate and. supporting the substrate in a vacuum chamber. A pressure within a vacuum chamber is reduced, and the temperature of the substrate is reduced such that the absolute temperature of the substrate is no greater than 20% of a melting temperature of the solder material. The absolute temperature is maintained while solder material is deposited onto the substrate.

Still another embodiment of the present invention is directed to a method of depositing solder material onto a substrate includes adjusting a pressure within a vacuum chamber, the substrate being supported within the vacuum chamber. A temperature of the substrate is reduced such that the homologous temperature of the solder material is less than 0.2. The homologous temperature is maintained while solder material is deposited onto the substrate.

The above and other objects and advantages of the present invention shall be made apparent from the accompanying drawings and the descriptions thereof.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a focus ion-beam-etched cross-section scanning electron micrograph of a sputtered indium film proximate a heat-spreader interface, deposited in accordance with conventional methods.

FIG. 2 is a flowchart illustrating a method of depositing a solder material in accordance with one embodiment of the present invention.

FIGS. 3A and 3B are schematic representations of a flip chip substrate, suitable for use with the method of FIG. 2 and including solder bumps registered with solder pads of a PC board substrate, before (FIG. 3A) and after (FIG. 3B) of the reflow process.

FIG. 4 is a schematic representation of a deposition chamber suitable for use with the method of FIG. 2.

FIG. 4A is an enlarged, cross-sectional view of a substrate support of the deposition chamber of FIG. 4.

FIG. 5 is a focus ion-beam-etched cross-section scanning electron micrograph of a sputtered indium film proximate a heat-spreader interface, deposited in accordance with the method of FIG. 2.

FIG. 6 is a schematic representation of another deposition chamber suitable for use with the method of FIG. 2.

### DETAILED DESCRIPTION OF THE INVENTION

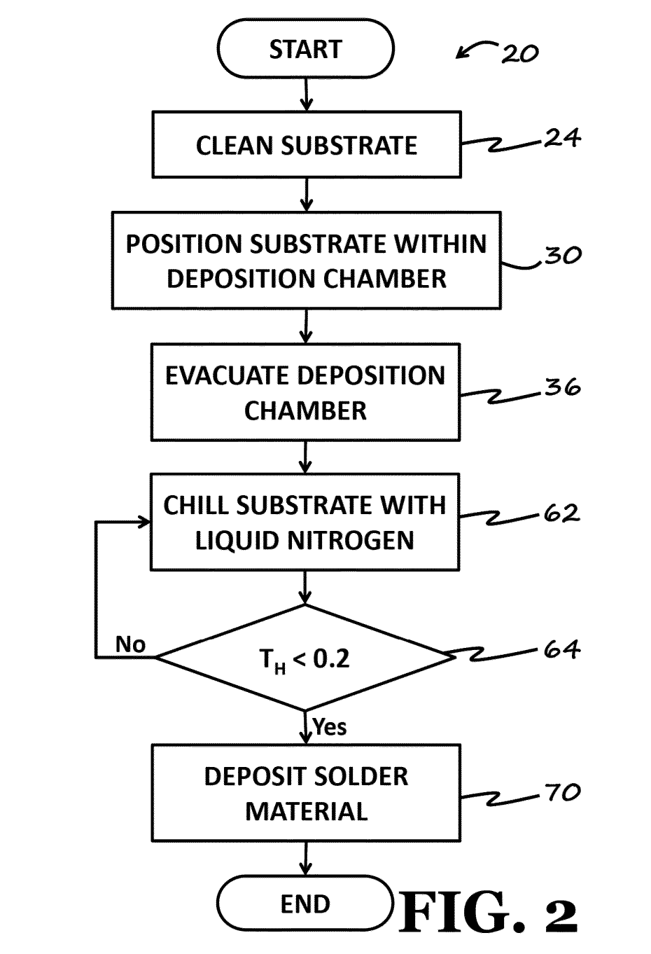

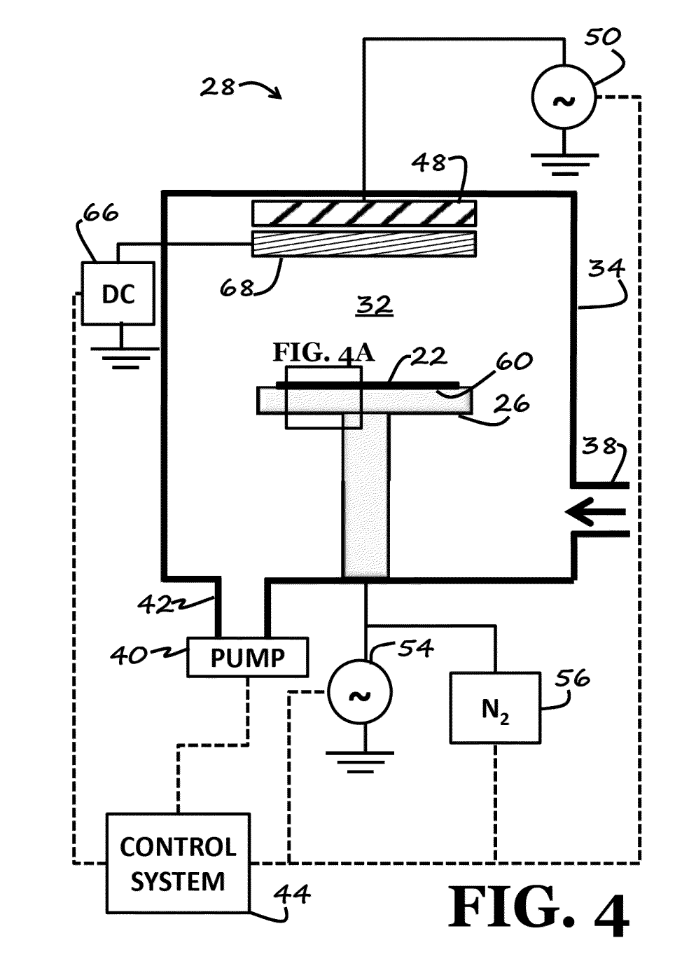

Turning now to the figures, and in particular to FIG. 2, a flowchart 20 depicting a method of depositing indium in accordance with one embodiment of the present invention is shown. At start, a substrate 22 (FIG. 4) may be cleaned in Block 24, for example, washing the substrate 22 (FIG. 4) with acetone, methanol, isopropyl, and deionized water. Residual surface H₂O is removed from the substrate 22 (FIG. 4) by drying under nitrogen gas and/or baking for two minutes at a temperature that is generally above 100° C.

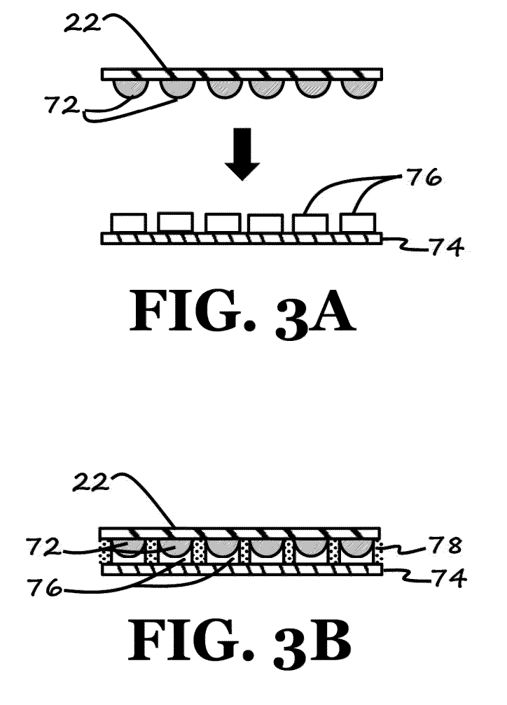

The substrate 22, according to one exemplary embodiment, may include flip chip technology. Briefly, flip chip technology, which is illustrated in FIGS. 3A and 3B, a plurality of solder bumps 72 are provided on a circuit side of the substrate 22 (or die) at bond pad sites (not shown) while a corresponding substrate 74 (or PC board) includes a corresponding number of solder pads 76 thereon, which are registered with the solder bumps 72. During bonding, a flux 78 is supplied between the solder bumps 72 and solder pads 74 and, with heating, the solder pads 74 reflow and physically connect with the solder bumps 72. Because the solder bumps 72 have a higher melting point than the solder pads 76, the solder pads 76 reflow and conform to the shape of the solder bumps 72.

In still another exemplary embodiment, the substrate may include a half vertical external cavity surface emitting laser (VECSEL) solder bonded to a high thermal conductivity heat spreader, which is described in ROBERT G. BEDFORD et al., “Recent VECSEL Developments for Sensors Applications,” Proc. of SPIE. Vol. 8242 (2012) 82420W, 9 pages, the disclosure of which is incorporated herein by reference, in its entirety.

Turning now to FIGS. 2 and 4, and after the substrate 22 is clean and cooled to room temperature (Block 24), the substrate 22 may be positioned on and mounted to a substrate support 26 within a deposition chamber 28 (Block 30). The deposition chamber 28 may be any vacuum deposition chamber suitable for depositing a selected solder material onto the substrate 22. For instance, the exemplary deposition chamber shown in FIG. 4, i.e., a sputter chamber 28, includes a processing space 32 enclosed within chamber walls 34.

In Block 36, pressure within the processing space 32 of the chamber 28 is reduced (for example, approximately 3×10⁻⁶ Torr) to levels suitable for the deposition process. More particularly, one or more inert processing gases may be injected into the processing space 32 via an inlet gas port 38 while a pump 40, fluidically coupled to processing space 32 via a duct 42, evacuates the processing space 32. The flow of processing gases, as metered by a mass flow controller (not shown), is adjusted with the pumping rate of the vacuum pump 40 to achieve the selected pressure. In this way, fresh process gases are continuously supplied to the processing space 32 for plasma sustainment and any spent process gases are eliminated.

A control system 44 is operably coupled to one or more of the various components of the deposition system 28 to facilitate and control the deposition process. Specifically, the control system 44 may be operably coupled to one or more power supplies, which are electrically-coupled to electrodes. Each electrode/power supply is configured to transfer energy into the deposition chamber 28 for effectuating a deposition process. A first electrode 48, for example, an antenna, may powered by an AC power supply 50 (such as an RF supply) and is configured to ignite and maintain a plasma (not shown) within the process space 30. A second electrode (not specifically shown, but included within the substrate holder 26), may also be powered by an AC power supply 54 and is configured to bias the substrate holder 26 (and thus the substrate 22) for purposes of drawing deposition materials from the plasma toward the substrate 22 for deposition thereon. While not considered to be limiting, the power supplies 50, 54 may operate at a frequency ranging between about 40 kHz and about 13.56 MHz and a power level ranging between about 4000 watts and about 8000 watts at 40 kHz or 300 watts to 2500 watts at 13.56 MHz.

Referring now to FIGS. 4 and 4A, and with the process space 30 sufficiently evacuated, a cold fluid may flow from a supply (illustrated as a liquid nitrogen supply 56 in FIG. 3A) through the substrate holder 26 so as to chill the substrate 22. The cold fluid may a liquid, as shown, or a gas. In that regard., the substrate holder 26 may include a plurality of fluid passages 58 therein, with or without exhaust passages (not shown) proximate a backside 60 of the substrate 22, such that the cold fluid lowers the temperature of the substrate holder 26 as well as the substrate 22 mounted thereto (Block 62). One of ordinary skill in the art will readily appreciate that the introduction of the cold fluid should not be initiated until the selected chamber pressure is achieved; otherwise, residual molecules (e.g., water) from within the processing space 32 may condense onto the cooled substrate 22 and inhibit solder material deposition.

Substrate chilling continues in this way until a temperature of the substrate 22 is such that the absolute temperature (wherein “absolute” refers to Kelvin scale) of the substrate 22 is less than 0.2 (or 20%) of the absolute melting temperature of the selected solder material, Said another way, the substrate temperature should be sufficiently reduced so that a homologous temperature (T_{H}) of the selected solder material is less than 0.2 (Decision Block 64), wherein T_{H} is a ratio of the absolute temperature of the substrate 22 and the absolute melting temperature of the selected soldering material.

Once the substrate 22 is sufficiently chilled (“Yes” branch of decision block 64), material may be deposited onto the substrate 22. In that regarding, a power supply 66, for example, a DC power source 66 energizes a target 68 comprising the soldering material, causing atoms of the soldering material to sputter off the target 68 and into the plasma of the processing space 32. The electrically biased substrate 22, via the associated power source 54, draws the atoms from the processing space 32 and onto the processing surface of the substrate 22 (Block 70).

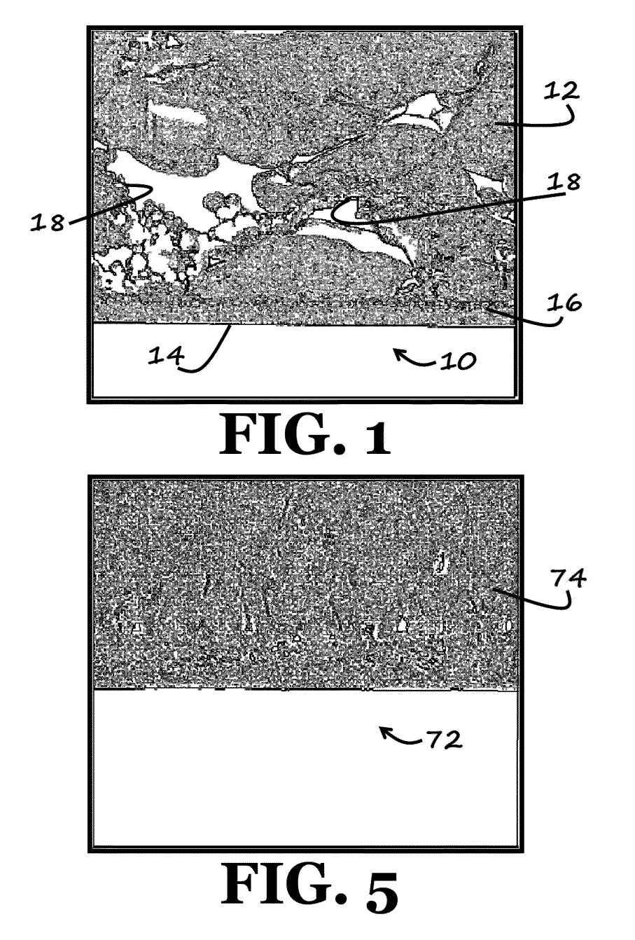

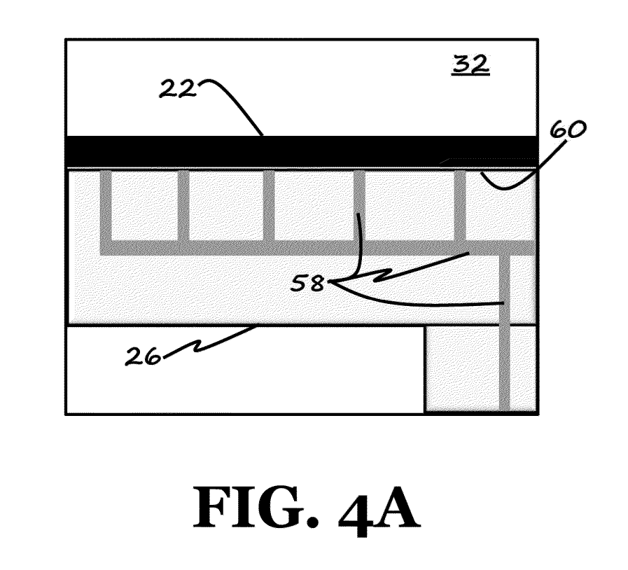

While not wishing to be bound by theory, it is believed that reducing the substrate temperature such that the homologous temperature, T_{H}, of the solder material is less than 0.2 reduces the surface energy of the deposited solder material and effectively limits reflow of the solder material and/or coalescence of caverns formed therein, as shown in FIG. 5. Said another way, cold liquid deposition methods according to embodiments of the present invention permit extreme cooling of the substrate 22, which reduces the mobility of the deposited atoms that would otherwise lead to large grain size and caverns 18 (FIG. 1).

Deposition of the solder material continues in a similar manner until a desired layer thickness (for example, 5 μm) is achieved. Although not specifically shown herein, it would be readily appreciated by the skilled artisan having the benefit of the disclosure herein that a plurality of deposition methods may be performed during a device fabrication process. For instance, multiple solder material layers, of similar or different material composition, may be deposited onto a substrate.

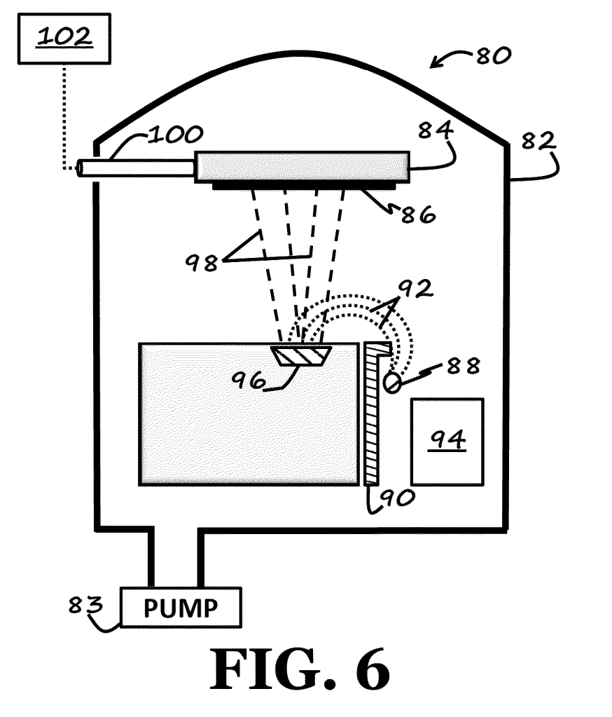

With reference now to FIG. 6, an alternative deposition system 80 suitable for use with one or more embodiments of the present invention is shown and described in detail. The deposition system 80, here an electron beam evaporation system, includes a vacuum chamber 82 (fluidically coupled pump 83) having a substrate support 84 therein configured to support a substrate 86 thereon. A DC power source (not shown in FIG. 6) is applied to a shielded filament 88 (conventionally comprising tungsten with a surrounding shield 90), causing electrons (illustrated as dotted lines 92) to be discharged. Under magnetic influence (magnet 94), electrons travel an arcuate path and impact a target 96 comprising the solder material, which sputters solder material (illustrated as dashed lines 98) toward the substrate 86.

In accordance with the embodiments of the present invention described herein, the substrate support 84 includes a chill line 100 extending to a cold fluid supply 102, which may include liquid nitrogen, as was described previously with respect to FIG. 4.

According to a method similar to the method described with respect to FIG. 2, the cold fluid is supplied to the substrate support 84 such that the substrate temperature is reduced to, and maintained at, a temperature such that the T_{H} of the selected solder material is less than 0.2.

The following example illustrates particular properties and advantages of some of the embodiments of the present invention. Furthermore, these are examples of reduction to practice of the present invention and confirmation that the principles described in the present invention are therefore valid but should not be construed as in any way limiting the scope of the invention.

### EXAMPLE

A conventional solder sputter system was modified to include a liquid platen cooling system configured to reduce the substrate temperature below room temperature and in a manner that is similar to the embodiment of the present invention illustrated in FIG. 4. Liquid nitrogen cooled the substrate and was recycled within the liquid platen cooling system.

Indium solder was deposited onto an uncooled, first, control substrate (nominal substrate temperature of about 300 K.) and with operational parameters as shown in Table 1. Indium solder was also deposited onto a second, cooled substrate (nominal substrate temperature of about 77 K.) with operational parameters similar to the first, control substrate,

TABLE 1

| | | |
|---|---|---|
| Parameter/ | Control | Cooled |
| Result | Substrate | Substrate |

| | | | | |
|---|---|---|---|---|
| Deposition | 2.2 | mTorr | 2.2 | mTorr |
| Pressure | | | | |
| Ar air | 11.96 | sccm | 11.96 | sccm |
| flow | | | | |

| | | |
|---|---|---|
| Substrate | Uncooled, nominally | Liquid nitrogen cooled |
| Temperature | 300 K | to 77 K |

| | | | | |
|---|---|---|---|---|
| Deposition | 8 | hours | 8 | hours |
| Time | | | | |
| Roughness | 630 | nm (RMS) | 23 | nm (RMS) |

The second, cooled substrate had few voids within the deposited indium layer; however the voids were smaller and more isolated as compared to the voids observed in the indium layer of the first, control substrate.

Both the first, control substrate and the second, cooled substrate were then subjected to solder bonding conditions (for example, 190° C). Voids within the indium layer of the first, control substrate coalesced during the bonding conditions; coalescence of the voids within the indium layer of the second, cooled. substrate was not observed. The thermal impedance of the deposited indium layer having the smaller, isolated voids of the second, cooled substrate is approximately an order of magnitude smaller than the thermal impedance that of the indium layer having larger voids.

Moreover surface roughness (about 23 nm) of the deposited solder material of the second, cooled substrate was improved by about 20-fold over the surface roughness of the first, control substrate. The surface roughness of the second, cooled substrate provided a. “minor-quality” to the indium solder material that dramatically improved solder bonding.

A method of depositing a solder material onto a substrate such that the grain size of the deposited layer is reduced, cavern formation is reduced, the overall layer thickness is decreased, and the layer surface is relatively smooth. Deposition includes reducing the temperature of the substrate such that the homologous temperature of the solder material is maintained below about 0.2 for the duration of the deposition process.

While the present invention has been illustrated by a description of various embodiments, and while these embodiments have been described in some detail, they are not intended to restrict or in any way limit the scope of the appended claims to such detail. Additional advantages and modifications will readily appear to those skilled in the art. The various features of the invention may be used alone or in any combination depending on the needs and preferences of the user. This has been a description of the present invention, along with methods of practicing the present invention as currently known. However, the invention itself should only be defined by the appended claims.

What is claimed is:

1. A method of depositing solder material onto a substrate using a vacuum-deposition system, the method comprising:
adjusting a pressure within a vacuum chamber of the vacuum-deposition system to a deposition pressure;
reducing a temperature of the substrate within the vacuum chamber to an absolute temperature that is no greater than 20% of a melting temperature of the solder material; and
maintaining the absolute temperature of the substrate while depositing the solder material onto the substrate.

2. The method of claim 1, wherein the vacuum-deposition system is a vapor deposition system or an electron beam evaporation system.

3. The method of claim 1, wherein reducing the temperature of the substrate comprises:
securing the substrate to a substrate support in the vacuum chamber, the substrate support having a plurality of fluid passages therein; and
flowing a cold fluid through the plurality of fluid passages.

4. The method of claim 3, wherein the plurality of fluid passages exhaust proximate a backside of the substrate.

5. The method of claim 1 further comprising:
reflowing the deposited solder material while maintaining the temperature.

6. The method of claim 1 further comprising:
cleaning a surface of the substrate before reducing the temperature of the substrate.

7. A method of fabricating a flip chip comprising:
preparing a bond pad site on a substrate;
supporting the substrate in a vacuum chamber of a vacuum-deposition system;
adjusting a pressure within the vacuum chamber of the vacuum-deposition system to a deposition pressure;
reducing a temperature of the substrate within the vacuum chamber to an absolute temperature that is no greater than 20% of a melting temperature of the solder material; and
maintaining the absolute temperature of the substrate while depositing the solder material onto the substrate.

8. The method of claim 7, wherein the vacuum-deposition system is a vapor deposition system or an electron beam evaporation system.

9. The method of claim 7, wherein reducing the temperature of the substrate comprises:
securing the substrate to a substrate support in the vacuum chamber, the substrate support having a plurality of fluid passages therein; and
flowing a cold fluid through the plurality of fluid passages.

10. A method of depositing solder material onto a substrate using a vacuum-deposition system, the method comprising:
adjusting a pressure within a vacuum chamber of the vacuum-deposition system to a deposition pressure;
reducing a temperature of the substrate within the vacuum chamber such that he homologous temperature of the solder material is less than 0.2; and
maintaining the homologous temperature while depositing the solder material onto the substrate.

11. The method of claim 10, wherein reducing the temperature of the substrate comprises:
securing the substrate to a substrate support in the vacuum chamber, the substrate support having a plurality of fluid passages therein; and
flowing a cold fluid through the plurality of fluid passages.
